(19) United States
(12) Patent Application Publication
(10) Pub. No.: US 2019/0214209 A1
(43) Pub. Date: Jul. 11, 2019

(54) Electromagnetic Adjustment Device, In Particular For Camshaft Adjustment

(71) Applicant: Kendrion (Villingen) GmbH, Villingen-Schwenningen (DE)

(72) Inventors: Rolf Hermann, Konigsfeld (DE); Andreas Kammerer, Obereschach (DE)

(73) Assignee: Kendrion (Villingen) GmbH, Villingen-Schwenningen (DE)

(21) Appl. No.: 16/332,250

(22) PCT Filed: Aug. 21, 2017
(86) PCT No.: PCT/EP2017/071014

§ 371 Date: Mar. 11, 2019

(30) Foreign Application Priority Data
Sep. 9, 2016 (DE) 10 2016 116 981.1

(51) Int. Cl. H01H 50/02; H01H 50/18; H01H 50/44; H01H 50/36; H01H 50/54; H01R 13/66; H01R 13/70

(52) U.S. Cl. CPC H01H 50/023; H01H 50/18; H01H 50/44; F01L 1/344; H01H 50/54; H01R 13/6683; H01R 13/70; H01H 50/36

(57) ABSTRACT

An electromagnetic adjustment device, in particular for camshaft adjustment, having a plug housing made of insulating potting material, in which a stationary coil unit and a sensor unit are seated in a potted manner, which each have terminals electrically connected via electrical lines to contact pins protruding on the plug housing, and to an actuating unit, in which at least one axially movable armature is seated, which is axially movable upon energizing of the coil unit, for example, to interact with at least one tappet of a camshaft adjustment unit of a motor vehicle, where the terminals and the electrical lines of the coil unit and the sensor unit to the contact pins are embedded in the potting material of the plug housing.

The invention relates to an electromagnetic adjustment device, in particular for camshaft adjustment, having the features of the preamble of claim 1.

Such an electromagnetic camshaft adjustment device is known, for example, from DE 20 2009 006 940 U1. This device has a plug housing, in which a stationary coil unit and a sensor unit are seated. The coil unit and the sensor unit each have terminals and are connected via electrical lines in a manner not described in greater detail to contact pins inside a plug section of the housing. The plug housing is seated on an actuating unit having an axially movable armature, which is axially movable upon energizing of the coil unit and interacts with a tappet of the camshaft adjustment unit of a motor vehicle. The housing has a cylindrical housing shell, which encloses a coil unit. In this case, the cylindrical housing is filled with a plastic potting material in such a way that the coil unit is extrusion coated. A lower end region of the coil unit still protrudes out of the potting material.

In a manner not shown in greater detail, the coil unit is connected in this case to a connecting line, which leads to contact pins which are externally accessible on the plug housing. These contact pins are seated in the cavity of a plug flange formed integrally on the plug housing. In addition, a sensor unit is fastened on the housing in such a way that approximately half of it is enclosed by the potting material and it protrudes with its lower half into a cavity of the plug housing. The sensor unit interacts in this case with a disk-shaped permanent magnet, so that during axial movement of the armature, a changing permanent magnetic field is detectable by the sensor unit and this can be supplied to subsequent electronic processing.

The comparatively complex installation of the individual components inside the plug housing and above all the contacting of the coil unit and the sensor represent a particular challenge in such electromagnetic camshaft adjustment devices. Proper sealing and/or leak-tightness of the contacts is to be ensured in this case, because the coils are exposed in the oil of the motor vehicle due to production. It is therefore necessary to make the individual contacts between the coils and the contact pins of the plug housing, on the one hand, and also between the sensor unit and the contact pins of the plug housing, on the other hand, absolutely oil-tight, because the contacts, which are generally welded in such electromagnetic camshaft adjustment devices, cannot come into contact with oil. This is because such a contact of the contacts with oil would result in undesired copper corrosion. Therefore, these welded contacts are regularly separately sealed once again by means of a further potting material after the installation of the sensor in the plug housing, by this further potting material being applied to the still exposed contacts.

Such separate sealing of the corresponding contacts in electromagnetic camshaft adjustment devices is, on the one hand, very complex and, on the other hand, requires additional method steps, which are contrary to a cost-effective production of the overall electromagnetic camshaft adjustment device. In this case, the risk additionally exists that flaws will occur during the application of the further potting material, which do not result in complete sealing of the corrosion-sensitive contacts.

The present invention begins here.

The present invention has the goal of avoiding the described disadvantages and refining the electromagnetic adjustment device specified at the outset in such a way that the individual components and in particular the contacts are made absolutely oil-tight.

This goal is essentially achieved according to the invention in that the plug housing consists of a potting material, in which both the coil unit and also the sensor and the associated electrical lines and terminals are completely embedded in the potting material.

This measure ensures that the critical components and contacts and/or electrical lines of the electromagnetic adjustment device are integrated absolutely oil-tight in the potting material of the plug housing, wherein the advantage is additionally achieved that a finished, manageable assembly having all electromagnetic components is provided, which only has to be placed on an actuating unit of the electromagnetic adjustment device and fastened thereon to provide a functional electromagnetic adjustment device.

Such an electromagnetic adjustment device is distinguished by simple installation of the electromagnetic actuator and absolute oil-tightness.

Further developments of such an electromagnetic adjustment device are specified in the dependent claims.

A further development of the invention provides that the electrical lines between the coil unit and the contact pins accessible externally from the plug housing and/or the electrical lines between the sensor unit and the contact pins accessible externally from the plug housing are formed as a metallic stamped grating and are inserted pre-bent in an injection mold, in which the plug housing is subsequently produced by extrusion coating.

The essential advantage of such prefinished stamped gratings is that the coil unit can already be connected thereto, on the one hand, and the coil unit with the stamped grating thus forms a prefinished structural unit, which is manageable very easily and can be inserted into the injection mold. This also applies to a further stamped grating, to which the sensor unit is connected.

This stamped grating having the fastened and connected sensor unit also forms a prefinished structural unit which is easily manageable. The stamped gratings are pre-bent accordingly and can be inserted in a simple manner into the injection mold of the plug housing. This also decisively simplifies the production process of the electromagnetic adjustment device.

It has proven to be expedient to provide both three electrical lines for the coil unit and three electrical lines for the sensor unit. Therefore, a total of six electrical lines are connectable to six contact pins, which can be connected via a suitable plug to a control electronics unit and/or analysis electronics unit.

Each of the three lines of the sensor is connected once to a ground terminal of the sensor, once to a supply potential of the sensor, and once to a signal line of the sensor.

In a so-called 2-pin camshaft adjuster, two coils are provided for the coil unit. These two coils are each provided with a positive terminal and a ground terminal, wherein the two ground terminals can be connected to one another. The two positive terminals and the common ground terminal are then connected to the three mentioned lines of the stamped grating. These three lines of the stamped grating are in turn connected according to the invention to three contact pins of the plug of the electromagnetic camshaft adjustment device.

If the electromagnetic adjustment device and, in particular, camshaft adjustment device is a so-called 1-pin actuator, for actuating only a single tappet, the coil unit can also only have a single coil. In this case, only two lines (positive and ground terminal) would be necessary.

In another further development of the invention, the coil unit has at least one coil which is wound onto a coil support. The coil support has an upper and a lower collar, wherein the two collars have different axial heights. In the widened collar, which can be the upper collar, for example, at least two contact pins are inserted as terminals, which are each electrically connected to coil wire ends of a coil wire of the coil. It has proven to be advantageous in this case to weld the contact pins to the coil wire ends. However, other electrical connection methods are also possible, for example, soldering, electrically-conductive adhesive bonding, or the like.

In a further embodiment of the invention, the armature of the actuating unit is designed as an armature pin, which engages centrally at least partially in a coil of the coil unit when the plug housing is placed on the actuating unit. Two such armature pins are provided in the implementation of a 2-pin actuator.

It has also proven to be advantageous to provide the actuating unit with shells consisting of metal in the form of circular segments, which engage at least partially into a cavity of the plug housing enclosing the coil unit. These shells consisting of metal in the form of circular segments, which can also be embodied as guide plates, are used for guiding the electromagnetic field which is generated upon energizing of the coil unit and thus in operation of the electromagnetic camshaft adjustment device.

To be able to fasten the plug housing on the actuating unit, it has proven to be advantageous for the plug housing to have a plate-shaped bottom part, into which bushings are extruded. The openings of these bushings are aligned in this case with corresponding fastening openings on the actuating unit, so that a screw connection of the plug housing to the actuating unit is enabled in a simple manner.

In a further development of the invention, the plug housing is closed by a cover. This can be a plastic cover which is fastened by means of laser welding or other fastening methods on the plug housing.

Finally, to enhance the oil-tightness, the coil unit can have at least one coil body, the coil support collars of which are provided with peripheral sealing lips, wherein the sealing lips are also extrusion coated by the potting material of the plug housing during the production of the plug housing, so that a secure and optimum seal is thus achieved.

A specific exemplary embodiment will be explained in detail on the basis of several figures for the further explanation of the electromagnetic camshaft adjustment device according to the invention. In the figures:

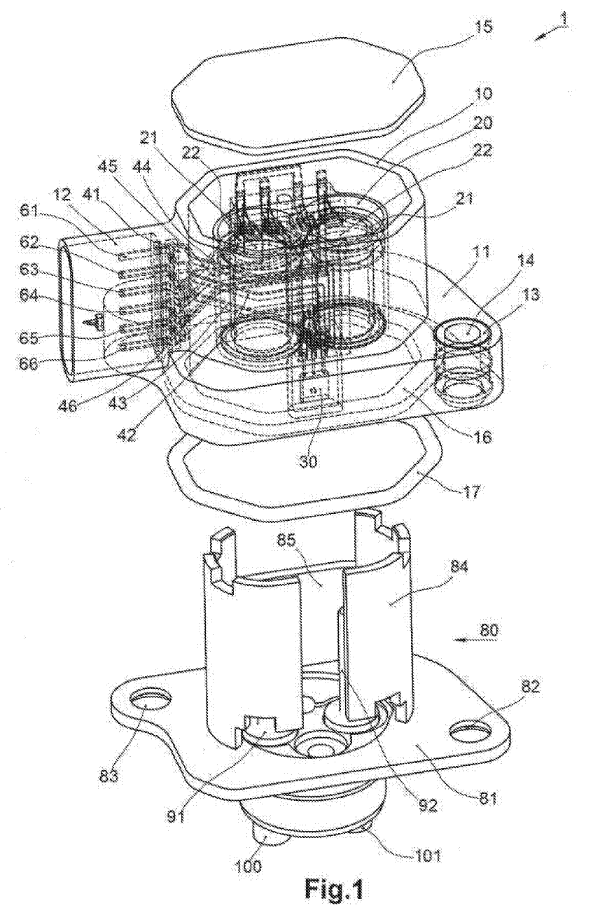

FIG. 1 shows an exploded illustration of an exemplary embodiment of an electromagnetic camshaft adjustment device according to the invention, wherein the plug housing is shown transparent for better comprehensibility,

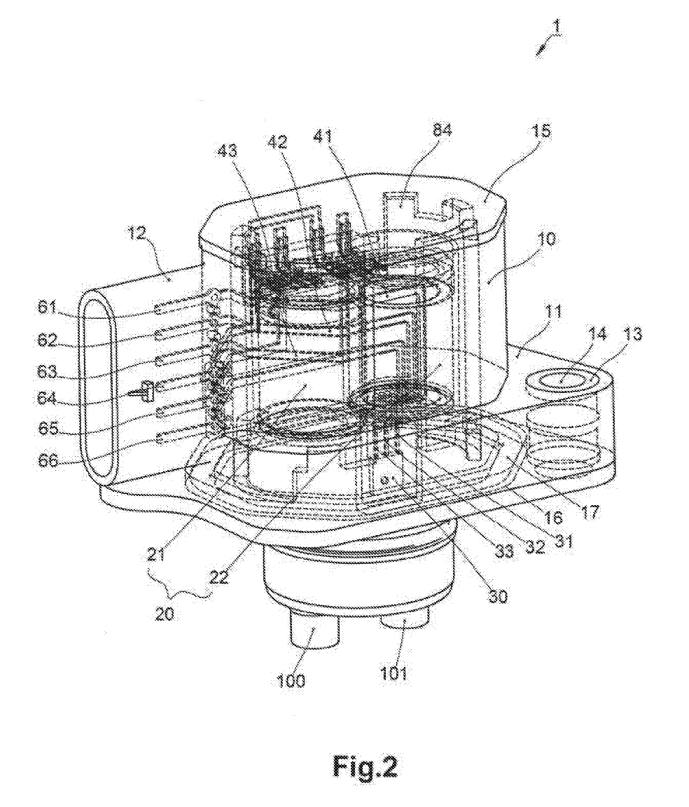

FIG. 2 shows the electromagnetic camshaft adjustment device according to FIG. 1 in the installed state,

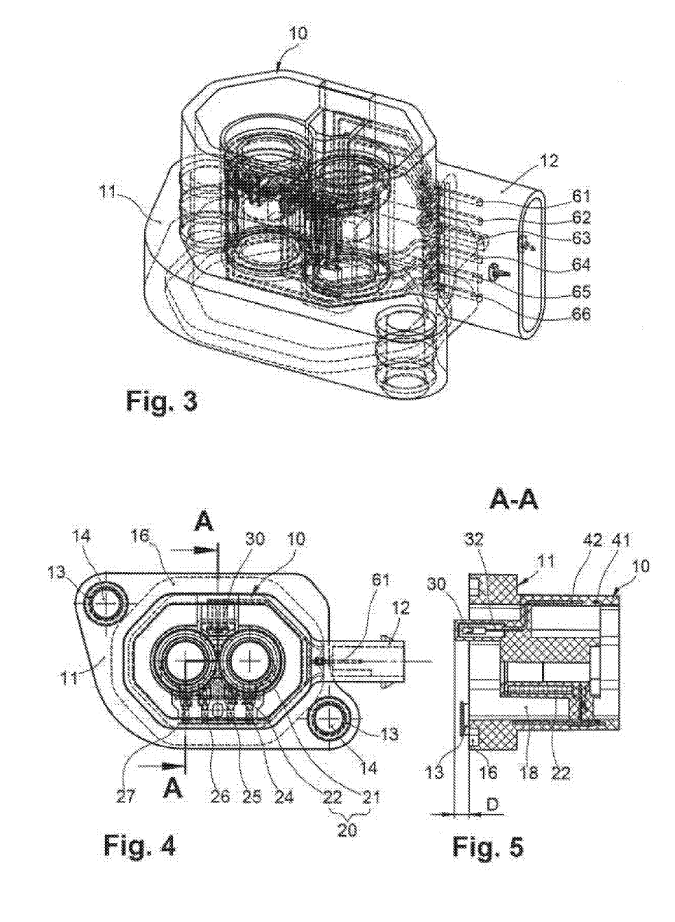

FIG. 3 shows the plug housing of FIGS. 1 and 2 in a perspective illustration in a transparent view together with the components installed therein,

FIG. 4 shows a cross-sectional illustration of the plug housing from FIG. 3 along section plane B of FIG. 3 with the components located therein,

FIG. 5 shows a sectional illustration of the plug housing illustrated in FIG. 4 along section line A-A,

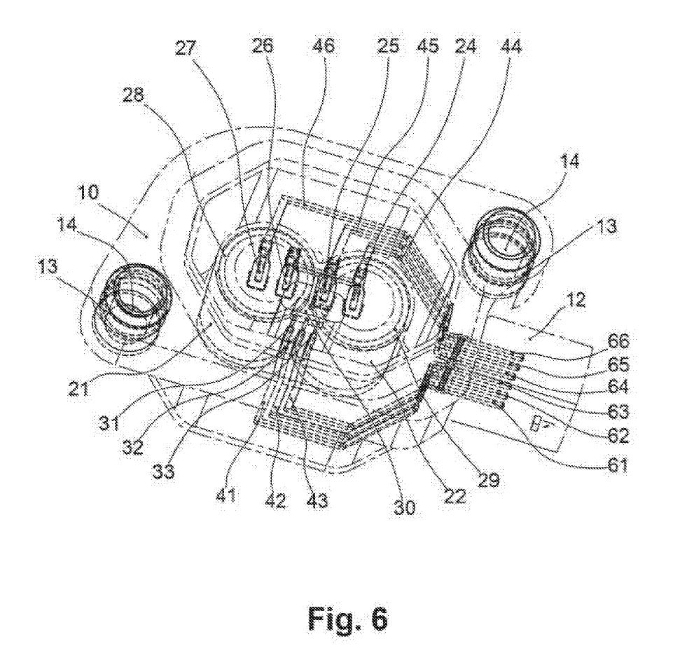

FIG. 6 shows a perspective illustration of the plug housing and the components located therein looking diagonally from below toward the plug housing,

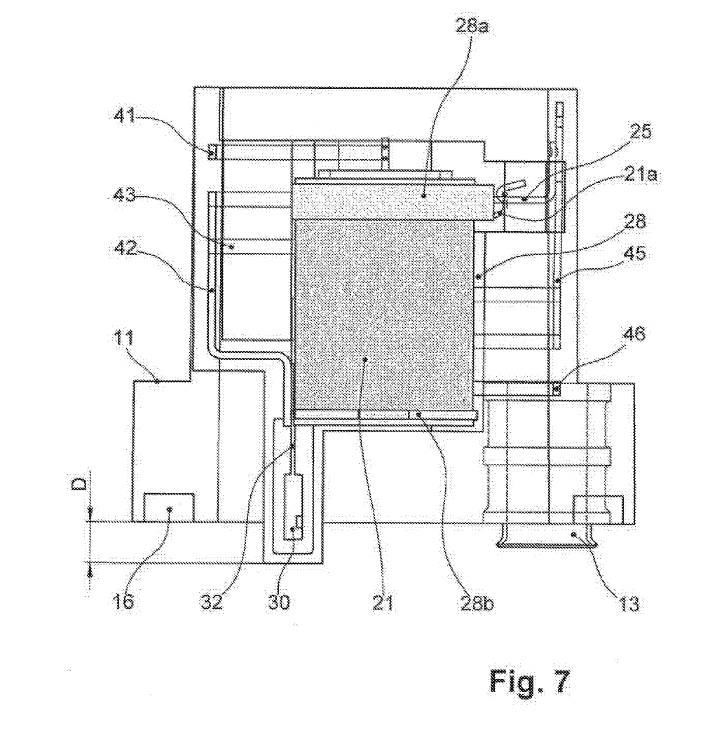

FIG. 7 shows a sectional view transversely through the plug housing, wherein the section is made between the two coils located in the plug housing,

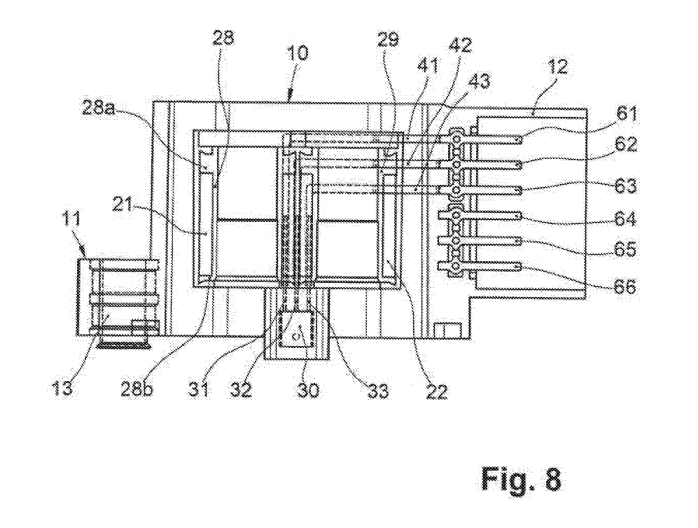

FIG. 8 shows a sectional illustration of the plug housing 10 along section line C-C from FIG. 3,

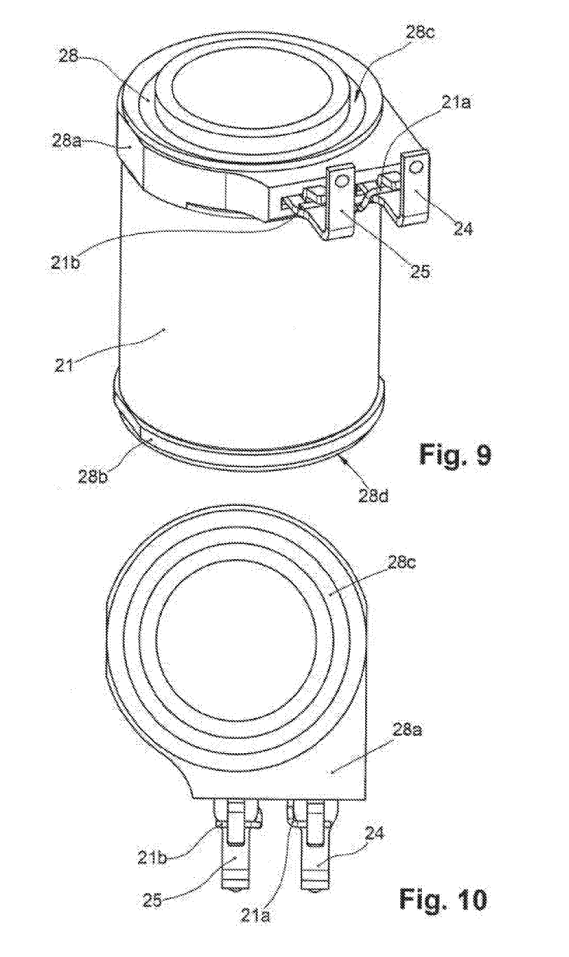

FIG. 9 shows a perspective view of one of the coils located in the plug housing including coil support in a perspective view, and

FIG. 10 shows the coil from FIG. 9 in a top view.

In the following description of the figures, identical reference numerals identify identical parts with identical meaning, if not indicated otherwise. In the following figures, for reasons of better comprehensibility and better understanding, the plug housing and the bottom part formed integrally therein as well as the integrally formed plug flange are each shown transparent to make the components located in the plug housing visible and to facilitate the understanding of the description of the figures, at the same time. It is self-evident that this plug housing obviously does not have to be made transparent, in reality. Any color design of the plug housing is possible. One particularly preferred color variant of the plug housing is for it to consist of black potting material.

One possible embodiment of an electromagnetic camshaft adjustment device is shown in FIG. 1, which is identified in general with the reference numeral 1. The electromagnetic camshaft adjustment device illustrated in FIG. 1 is a so-called “2-pin actuator”, in which two tappets 100, 101 engage in adjustment grooves of an internal combustion engine for camshaft adjustment. Upon corresponding energizing of a coil unit to be explained hereafter, these tappets 100, 101 can be moved back and forth axially to effectuate the camshaft adjustment. Instead of a “2-pin actuator,” the electromagnetic camshaft adjustment device can also be designed as a so-called “1-pin actuator,” in which only a single tappet engages in a single adjustment groove of a camshaft of an internal combustion engine and adjusts it.

It is to be expressly noted in this context that the electromagnetic adjustment device according to the invention is preferably provided for the adjustment of camshafts in order to move the mentioned tappet or tappets, but can also be used for any other adjustment tasks, which is not restricted to usage in motor vehicles.

The electromagnetic camshaft adjustment device 1 has a plug housing 10 made of plastic potting material, on which a plate-shaped bottom part 11 is integrally formed. This bottom part 11 protrudes beyond an approximately circular or oval housing wall of the plug housing 10, wherein two diametrically opposing bushings 13 having central openings 14 are held potted in this protruding region (cf. FIG. 4 in this regard). These bushings 13 are used for fastening the plug housing 10 on a fastening unit 80 to be explained hereafter and an engine housing (not shown in FIG. 1) of a motor vehicle. In addition, a plug flange 12 is integrally formed on the plug housing 10. This plug flange 12, which preferably has an oval cross-sectional shape and contains contact pins 61-66 to be explained hereafter, protrudes away to the left from the plug housing 10 in the illustration of FIG. 1.

As FIG. 1 shows, the plug housing 10 is closed on its upper side by a cover 15, preferably also a cover made of plastic. This cover 15 is placed on the plug housing 10 to form a seal in this case. The mechanical connection to the plug housing 10 can be produced, for example, by ultrasonic welding, adhesive bonding, or similar fastening methods. It is important in this case that the cover 15 is seated as leak-tight as possible on the plug housing 10.

The plug housing 10 has, on its lower side facing away from the cover part 15 and thus on the lower side of the bottom part 11, a peripheral groove 16, into which a sealing ring 17 is inserted when the plug housing 10 is placed on the actuating unit 80 and thus the electromagnetic camshaft adjustment device is installed. This assembled state of plug housing 10 and actuating unit 80 is illustrated in FIG. 2.

As already mentioned, the plug housing 10 consists of plastic potting material. In this case, all electrical components, contacts, and connecting lines are potted in the potting material of the plug housing 10 and completely and extensively embedded therein, so that absolute leak-tightness is ensured. Only the above-mentioned contact pins 61-66, to which the electrical components potted in the plug housing 10 are electrically connected, protrude out of the potting material.

The potting and the embedding of the electrical components, terminal contacts, and electrical lines can be seen particularly clearly in the sectional illustration of FIG. 5, in which the potting material of the housing 10 is shown crosshatched along section line A-A of FIG. 4.

A coil unit 20 having two coils is seated in the plug housing 10, which the exemplary embodiment for implementing a “2-pin actuator” has, namely a first coil 21 and a second coil 22. Both of these coils 21, 22 are preferably embodied identically. The coil 21 is shown in a perspective view and also enlarged in a top view in FIGS. 9 and 10. The coil 21 is wound onto a coil support 28. This coil support 28, which preferably also consists of plastic, has an upper collar 28a and a lower collar 28b. These two collars 28a, 28b protrude somewhat beyond the external diameter of the outer winding of the coil 21 and delimit it. The upper collar 28a of the coil support 28 is significantly taller than the lower collar 28b of the coil support 28. This is necessary to be able to insert electrical terminals 24, 25 in the form of contact bows laterally into the peripheral wall of the upper collar 28a. The two coil ends 21a, 21b of the coil 21 are electrically connected to these terminals 24, 25, for example, by a tab of the contact pins, which are used as the terminals 24, 25, clamping the coil ends 21a, 21b and thus electrically contacting them. In addition, both the upper collar 28a and the lower collar 28b of the coil support 28 each have a peripheral sealing lip 28c, 28d, which ensure an optimum thermoplastic bond to the potting material of the plug housing 10 and thus an optimal sealing effect during the production of the plug housing 10 and the potting of the coil 21 (and also the coil 22) linked thereto.

The second coil 22 is constructed in a similar manner as the explained coil 21 and similarly has contact pins, to which the coil ends of the second coil 22 are electrically connected. These contact pins form the terminals 26, 27 of the second coil 22.

The terminals 24, 25 of the first coil 21 and the terminals 26, 27 of the second coil 22 are electrically connected via electrical lines to the contact pins 64, 65, 66 of the plug housing 10. In this case, the electrical lines are implemented as a metallic stamped grating having three lines. These three lines of the stamped grating preferably extend parallel to one another in sections and contact the terminals 24, 25 of the first coil 21 and the terminals 26, 27 of the second coil 22. In this case, the terminal 24 of the first coil 21 and the terminal 26 of the second coil 22 are short-circuited with one another via a contact bow, since they are at ground. The two terminals 24, 26 are thus jointly connected to the electrical line 44 of the stamped grating (cf. FIG. 6 in this regard). The terminal 25 of the first coil 21 is connected to the line 45 of the stamped grating and the terminal 27 of the second coil 22 is connected to the line 46 of the stamped grating.

In manufacturing, the coils 21, 22 preassembled with the terminals 24 to 27 thereof are supplied to an installation unit, in which the terminals 24 to 27 of the coils 21, 22 are welded onto the corresponding three lines 44, 45, 46 of the stamped grating. At the other ends thereof, this prefinished stamped grating is provided with the contact pins 64, 65, 66. The stamped grating having its lines 44, 45, 46 and the associated contact pins 64, 65, 66 and also the welded-on coils 21, 22 is then also pre-bent accordingly and inserted into an injection mold, in which the plug housing 10 is produced by means of injection molding.

In addition, a further stamped grating, which has the above-mentioned contact pins 61, 62, 63 at one end and which is electrically connected to a sensor unit 30 at the other end, is also inserted into this injection mold. The sensor unit 30 can be, for example, a Hall sensor, which is provided in operation of the electromagnetic camshaft adjustment device for the purpose of detecting an axial position of the mentioned tappets 100, 101 or the armature 90 operationally connected to these tappets 100, 101. This sensor unit 30 has, for example, three terminals 31, 32, 33, which can be formed as contact pins of an integrated circuit of the sensor unit 30. These terminals 31, 32, 33 are electrically connected to the lines 41, 42, 43 of the stamped grating, for example, again by welding.

In a further preassembly station, this sensor unit 30 is welded onto the lines 41, 42, 43 of the stamped grating. This second unit preinstalled in this way, consisting of the second stamped grating having the lines 41, 42, 43 and the welded-on sensor unit 30, is bent in a suitable manner and also inserted into the injection mold for extrusion of the plug housing 10.

In addition, the two bushings 13 are also inserted into the injection mold, as shown particularly clearly in FIG. 6. Subsequently, the potting material is introduced into the injection mold to extrude the plug housing 10 made of plastic. In this case, the injection mold and the negative injection mold are designed in such a way that all terminals 24, 25, 26, 27 of the two coils 21, 22 and the terminals 31, 32, 33 of the sensor unit 30 are completely extrusion coated using plastic and thus sealed. In addition—except for the contact pins 61-66 protruding into the plug flange 12—all lines 41-46 of the two stamped gratings are also completely extrusion coated using plastic. Finally, the coils are also completely extrusion coated using plastic material, as shown particularly clearly in the sectional illustration of FIG. 5. Particularly the tubular inner wall of the coil support can also be completely extrusion coated with the potting material in this case.

Optimum sealing of all components inside the plug housing 10 is thus ensured. Moreover, a component which is very simple to handle is provided by the described production method, which only has to be placed on the actuating unit 80, as shown in FIG. 1.

This actuating unit 80 has a bottom plate 81 consisting of metal, for example, which approximately corresponds to the dimensions of the bottom plate 11 of the plug housing 10. Fastening boreholes 82 are incorporated into this bottom plate 81 of the actuating unit 80 aligned with the openings 14 of the fastening bushings 13 of the plug housing 10. The above-mentioned tappets 100, 101, which are used for the camshaft adjustment and are each operationally connected to a pin-shaped armature 91, 92, protrude out of the lower side of this bottom plate 81. When the plug housing 10 is placed on the actuating unit 80, these two armatures 91, 92 engage at least partially in the central openings of the coils 21, 22. The armatures 91, 92 can be axially moved in this way upon energizing of the coils 21 and/or 22, to which an axial movement of the tappets 100, 101 is linked. The mentioned sensor unit 30 can detect this axial movement.

In addition to the armatures 91, 92 and the tappets 100, 101, the actuating unit 80 also has a metallic, tubular guide plate 84, which engages into a cavity 18 (cf. FIG. 5 in this regard) of the plug housing 10 formed around the two coils 21, 22 of the coil unit 20. In order that the actuating unit 80 can be inserted into this cavity 18 of the plug housing 10, the guide plate 84 has a longitudinal slot 85, past which the sensor unit 30 can be pushed during the installation of the plug housing 10 and the actuating unit 80.

As is apparent from the sectional illustration of FIG. 5 of the plug housing 10 having the electrical components potted therein as well as the electrical lines and the terminals, the potting material of the plug housing 10 completely encloses these components. Therefore, the coils 21, 22, the sensor unit 30, and the associated terminals 24 to 27 and 31 to 33, respectively, as well as connecting lines 44 to 46 are all sealed off and optimally protected particularly with respect to contact with motor oil.

Finally, FIG. 5 also shows a special feature which is that the sensor completely potted by potting material of the plug housing 10, i.e., the sensor unit 30, protrudes somewhat beyond the footprint of the base plate 11 by an excess D. This is necessary so that the sensor unit 30 can optimally detect a permanent magnet and its magnetic fields, which is movably arranged with the armatures 91, 92 and is not shown in the figures for better comprehensibility. In addition, FIG. 5 shows that the bushings 13 also protrude somewhat beyond the footprint of the bottom part 11. These bushings 13 can thus be used in a simple manner as an alignment aid, by this protruding region of the bushings 13 being able to engage into the mentioned openings 82 of the actuating unit 80.

### LIST OF REFERENCE NUMERALS

1 electromagnetic adjustment device, in particular camshaft adjustment device plug housing
11 bottom part
12 plug flange
13 bushing
14 opening
15 cover
16 sealing ring
17 groove
18 cavity
coil unit
21 coil
21a coil wire end
21b coil wire end
22 second coil
23
24 terminal
25 terminal
26 terminal
27 terminal
28 first coil support
28a upper collar of 28
28b lower collar of 28
28c peripheral sealing lip on 28a
28d peripheral sealing lip on 28b
29 second coil support
29a upper collar of 29
29b lower collar of 29
30 sensor unit
31 terminal
32 terminal
33 terminal
41 electrical line
42 electrical line
43 electrical line
44 electrical line
45 electrical line
46 electrical line
61 contact pin
62 contact pin
63 contact pin
64 contact pin
65 contact pin
66 contact pin
80 actuating unit
81 bottom plate
82 fastening opening
83 fastening opening
84 tubular guide plate
85 slot
91 armature
92 armature
100 tappet
101 tappet
A-A section
B plane of section
C-C section
D excess

1. An electromagnetic adjustment device, comprising:
a plug housing made of insulating potting material, in which a stationary coil unit are seated in a potted manner, each having terminals that are electrically connected via electrical lines to contact pins protruding on the plug housing, and to an actuating unit, in which at least one axially movable armature is seated, and which is axially movable upon energizing of the coil unit, and
wherein the terminals and the electrical lines of the coil unit and the sensor unit to the contact pins are embedded in the potting material of the plug housing.

2. The electromagnetic adjustment device, as claimed in claim 1,
wherein the electrical lines between the coil unit and the contact pins and/or the electrical lines between the sensor unit and the contact pins are formed as a metallic stamped grating and/or inserted pre-bent into the plug housing.

3. The electromagnetic adjustment device, as claimed in claim 1,
wherein three electrical lines, are provided between the coil unit and the contact pins and three electrical lines are provided between the sensor unit and the contact pins.

4. The electromagnetic adjustment device, as claimed in claim 1,
wherein the coil unit has at least one coil support, on which a coil is wound, and an upper collar and a lower collar, which have different axial heights, and
wherein at least two contact pins are inserted as terminals into the upper collar or lower collar, and wherein each contact pin of the at least two contact pins are each electrically connected to a respective coil wire end of a coil wire of the coil.

5. The electromagnetic adjustment device, as claimed in claim 4,
wherein each contact pin of the at least two contact pins are welded to the respective coil wire end.

6. The electromagnetic adjustment device, as claimed in claim 1,
wherein the armature of the actuating unit is formed as an armature pin and engages centrally in the coil of the coil unit when the plug housing is placed on the actuating unit.

7. The electromagnetic adjustment device, as claimed in claim 1,
wherein the actuating unit has shells, each shell in the form of circular segments or a guide plate, and which engage at least partially into a cavity of the plug housing surrounding the coil unit.

8. The electromagnetic adjustment device, as claimed in claim 1,
wherein the plug housing has a plate-shaped bottom part into which bushings are extruded.

9. The electromagnetic adjustment device, as claimed in claim 1,
wherein the plug housing is closed by a cover.

10. The electromagnetic adjustment device, as claimed in claim 1,
wherein the coil unit has at least one coil body having coil support collars, which are provided with peripheral sealing lips and the sealing lips are inserted into the potting material of the plug housing.

11. An electromagnetic adjustment device, comprising:
a plug housing made of insulating potting material and with plug housing contact pins that protrude out of the potting material;
a stationary coil unit seated in the plug housing and having a stationary coil contact terminal, wherein the stationary coil unit and the stationary coil contact terminal are embedded in the potting material of the plug housing;
a sensor unit seated in the plug housing and having a sensor unit contact terminal, wherein the sensor unit and the sensor unit contact terminal are embedded in the potting material of the plug housing;
a first electrical line electrically connecting the stationary coil contact terminal to a plug housing contact pin of the plug housing contact pins, wherein the first electrical line is embedded in the potting material of the plug housing; and
a second electrical line electrically connecting the sensor unit to a plug housing contact pin of the plug housing contact pins, wherein the second electrical line is embedded in the potting material of the plug housing.

12. The electromagnetic adjustment device as claimed in claim 11, wherein each of the stationary coil unit, the sensor unit, the first electrical line and the second electrical line do not protrude beyond the potting material in which they are embedded such that each are covered by the potting material in which each is embedded.

13. The electromagnetic adjustment device as claimed in claim 11, further comprising an actuating unit coupled to the plug housing, the actuating unit having an armature that is axially movable upon energizing of the stationary coil unit.

14. The electromagnetic adjustment device as claimed in claim 11, wherein the first electrical line, the second electrical line, or both the first electrical line and the second electrical line, are metallic stamped grating that are embedded in the potting material of the plug housing.

15. The electromagnetic adjustment device as claimed in claim 11, wherein the first electrical line, the second electrical line, or both the first electrical line and the second electrical line, are inserted pre-bent into the plug housing prior to being embedded in the potting material of the plug housing.
